(19) United States
(12) Patent Application Publication
(10) Pub. No.: US 2008/0132369 A1
(43) Pub. Date: Jun. 5, 2008

(54) Longitudinal Spring Damper for Damping Chain Vibration

(75) Inventor: Surendar Paul, Farmington Hills, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GENERAL MOTORS CORPORATION

(21) Appl. No.: 11/565,986

(22) Filed: Dec. 1, 2006

(51) Int. Cl. F16G 15/12

(52) U.S. Cl. 474/226

(57) ABSTRACT

A longitudinal spring damper link for a power transmission chain is provided. The spring damper link has a metallic body formed of spring steel with two opposing ends and a spring portion contained in a middle section positioned between and interconnecting the ends. Each end has an aperture for receiving a chain roller pin therethrough. The spring damper link is elastically elongatable, the elongation generating a tensile force in the spring portion acting to tension the chain, thereby dampening longitudinal vibrations in the chain.

### TECHNICAL FIELD

The present invention relates to a chain for transmitting mechanical power between a plurality of powered drive devices and driven devices, and more particularly to a power transmission chain equipped with one or more longitudinal spring dampers configured to elastically tension the chain and thereby dampen chain vibration.

### BACKGROUND OF THE INVENTION

When chains are applied to transmit mechanical power between drive and driven devices, chains are known to exhibit a longitudinal wave or loaded resonance vibration. This vibration occurs when the tooth engagement frequency matches a natural vibration frequency of the chain. Such undamped vibration is known to result in poor life performance of the chain (for example, increased chain wear), as well as the generation of undesirable noise, vibration and heat.

Several workarounds are known to alleviate the issue of chain vibration. It is known, for example, to include a plurality of traverse springs in chains, the traverse springs configured to apply a traverse force so as to compress adjacent rows of links in a chain together. The traverse springs increase friction between adjacent rows of chains and thereby increases the force required to bend or deflect the chain. The increased frictional force is applied to dampen the longitudinal vibration in the links of the chain. As can be understood, portions of chains are required to deflect in normal operation. In operation, a chains wraps around and conforms to the perimeter radius of a sprocket wheel, then later straightens out, for example in the tensioned chain portion extending between sprocket wheels. The addition of a frictional force resisting flexing of the chain decreases the efficiency of power transmission through the chain and generates heat.

It is known to utilize a snubber to dampen chain vibrations. One variety of such a snubber has a drag member that engages against the side of the chain. In some embodiments the snubber is a piece of molded rubber positioned to rub against the chain. In some cases a spring element is provided that is configured to press the snubber against the chain, thereby effecting tensioning of the chain, the tensioning acting to dampen chain oscillations. In many applications, adding one or two snubbers to dampen chain vibration is not feasible due to space and added cost issues.

Additionally, it is known that as chains wear they tend to stretch or elongate. Chain elongation resulting from chain wear increases the likelihood of chain noise and vibration as it increases slack in the chain.

### SUMMARY OF THE INVENTION

The present invention provides a longitudinal spring damper for a power transmission chain, the longitudinal spring damper adapted and configured to dampen chain vibrations and oscillations, thereby improving chain life and reducing chain noise.

The longitudinal spring damper is a chain link having a formed metallic body having a spring elastic portion preferably formed from a variety of spring steel. The longitudinal spring damper chain link has two opposing ends with each end having an aperture sized and configured for receiving a roller pin therethrough. In a preferred embodiment, the ends of the longitudinal spring damper chain link lie generally in a common plane. The longitudinal spring damper chain link has a middle section which is positioned between and interconnected to the opposing ends of the link. This middle section is provided with a spring portion which acts longitudinally along the longitudinal spring damper chain link to allow for elastic extension of the link while resisting elongation of the link by a tensile spring force generated by the spring portion of the longitudinal spring damper in a chain link. In operation, the longitudinal spring damper chain link is adapted to elastically elongate in response to an external tensile force applied to the opposing end apertures. When the longitudinal spring damper chain link is at rest, i.e. not tensioned by an external tensile force applied to the opposing end apertures, the distance between the opposing end apertures is a first distance. When an external tensile force is applied to the longitudinal spring damper chain link at the apertures on the opposing ends of the longitudinal spring damper link, an internal tensile force is generated by the spring portion of the longitudinal spring damper chain link which acts to urge the spring damper link apertures in a direction to return to the first distance.

According to one aspect of the invention, the spring portion of the longitudinal spring damper material includes spring steel.

According to another aspect of the invention, the spring portion of the longitudinal spring damper in a chain link is a raised spring portion generally extending outwards from the link to one side of the link and in a direction generally normal to the plane defined by the opposing ends of the link.

According to another aspect of the invention, the spring portion of the longitudinal spring damper link is a curved raised spring portion, the curved portion tending to flatten out to some degree in response to the application of an external tensile force between the opposing apertures of the ends of the longitudinal spring damper link.

According to another aspect of the invention, the spring portion of the longitudinal spring damper links is a raised curved spring portion having a generally triangular shape.

According to another aspect of the invention, a power transmission chain is provided having a plurality of spaced parallel roller pins arranged with immediately adjacent pins in a spaced parallel arrangement. The chain includes a plurality of inner links interleaved in rows of adjacent links. Each of the inner links is provided with a pair of apertures. The inner links are interconnected by roller pins inserted through the apertures. The rows of interconnected inner links form an inner portion of the power transmission chain. A plurality of longitudinal spring damper links, specifically those disclosed above, are provided. The longitudinal spring damper links additionally serve the function of chain guide links, forming the two opposing outermost rows of the chain (i.e. outermost rows on opposing sides of the rows of inner links). Each spring damper link has a formed metallic body having two opposing ends and a middle section positioned between and interconnecting the opposing ends. An aperture is provided in each opposing end for receiving a roller pin therethrough. The middle section of the longitudinal spring damper link has a spring portion, which in certain embodiments extends above the plane defined by the opposing ends of the longitudinal spring damper link. The spring portion is configured to enable the spring damper link to be elastically elongated in response to an external tensile force applied to the spring damper link at the opposing end apertures. The spring portion is configured to generate a counteracting internal tensile force resisting the elastic elongation. The power transmission chain is configured with one aperture of each row of inner links and one aperture of each row of spring damper links having a common roller pin extending therethrough. An external tensile force applied to the longitudinal spring damper link through the chain and roller pins acts to elastically elongate the longitudinal spring damper link by elongating the spring portion of the middle section of the spring damper link. Elongating the spring portion of the middle section generates a counteracting internal tensile force that acts to reduce the distance between the apertures of the spring damper link, thereby urging the longitudinal spring damper link to return to its original length before the external tensile force was applied. The counteracting internal tensile force acts to urge the chain roller pins into closer spacing to tension the chain and thereby to dampen chain longitudinal vibrations.

According to another aspect of the invention, a power transmission chain for transmitting power from a sprocket wheel is provided. The chain includes a plurality of inner links interleaved in rows of adjacent links. Each inner link is provided with a pair of apertures. The inner links are interconnected by the roller pins inserted through the apertures. The rows of interconnected links form an inner portion of the power transmission chain. None, some or all of the inner links are provided with at least one extending portion configured to driveably engage a sprocket tooth of a sprocket wheel. A plurality of longitudinal spring damper links, specifically those disclosed above, are provided. The longitudinal spring damper links additionally serve the function of chain guide links, forming the two opposing outermost rows of the chain (i.e. each outermost row on an opposing side of the rows of inner links). Each spring damper link has a formed metallic body having two opposing ends and a middle section positioned between and interconnecting the opposing ends. An aperture is provided in each opposing end for receiving a roller pin therethrough. The middle section of the longitudinal spring damper link has a spring portion extending above the plane defined by the opposing ends of the longitudinal spring damper link. The spring portion is configured to enable the spring damper link to be elastically elongated in response to an external tensile force applied to the opposing end apertures. The spring portion is configured to generate an internal tensile force resisting the elastic elongation as discussed earlier above.

According to another aspect of the invention, a power transmission chain for transmitting power from a sprocket wheel further includes longitudinal spring damper links as discussed above in which at least some of the longitudinal spring damper links have at least one of the ends configured to driveably engage a sprocket tooth of a sprocket wheel.

According to another aspect of the invention, the longitudinal spring damper links may be installed in the inner portion of the chain, replacing a portion of the chain inner links.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 illustrates a front view of a chain link such as a guide link as known in the prior art;

FIG. 2A illustrates a front view of a longitudinal spring damper link in accordance with one or more aspects of the present invention;

FIG. 2B illustrates a top view of the longitudinal spring damper link of FIG. 2A;

FIG. 3A illustrates a top view of a power transmission chain incorporating the longitudinal spring damper links as guide links, the spring damper links symmetrically arranged on opposing sides of the chain in accordance with one or more aspects of the present invention;

FIG. 3B illustrates a top view of a power transmission chain incorporating the longitudinal spring damper links as guide links, the spring damper links in a staggered arrangement on opposing sides of the chain in accordance with one or more aspects of the present invention;

FIG. 4 illustrates a perspective view of the longitudinal spring damper link of FIGS. 2A and 2B more clearly presenting the curved raised spring portion;

FIG. 5 illustrates a front view of a longitudinal spring damper link driveably engaging one or more sprocket teeth of a sprocket wheel in accordance with one or more aspects of the present invention; and

FIG. 6 illustrates a partial front view of an end aperture of an inner plate or inner link for a chain, illustrating the tolerance gap between the roller pin and the aperture wall.

### DESCRIPTION OF THE PREFERRED EMBODIMENTS

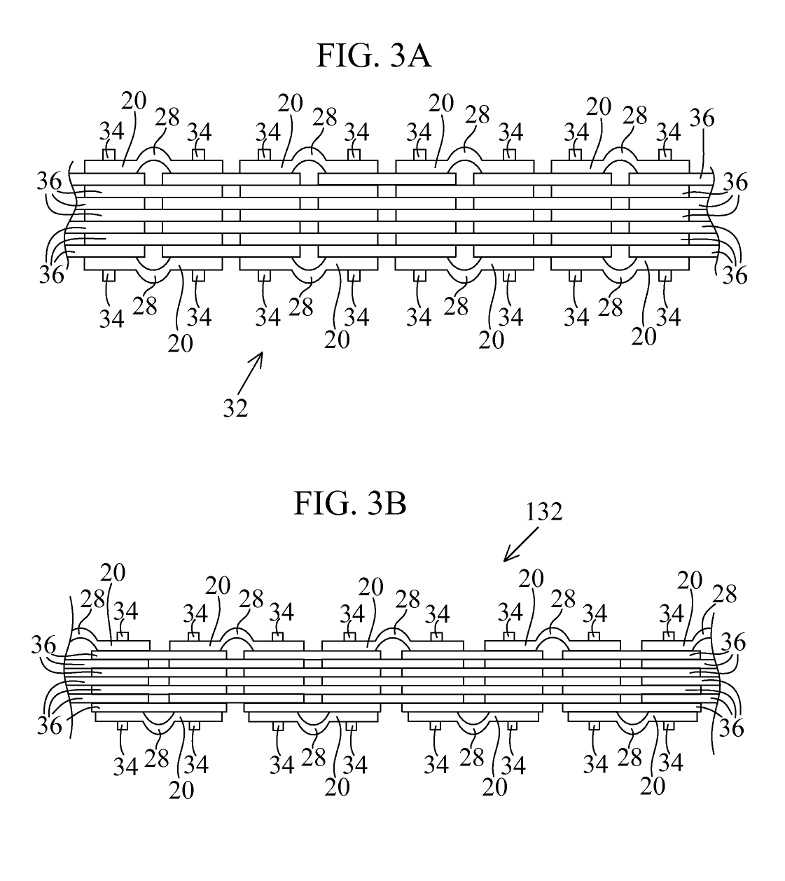

FIG. 1 illustrates a front view of a chain link such as a prior art guide link 10. Guide plate or guide link 10 has a metallic body having a two opposing ends 12, each opposing end 12 having an aperture 14 for receiving a roller pin (shown and discussed later) therethrough. A middle section 16 is positioned between and interconnects the opposing ends 12. The middle section 16 lacks a longitudinally elastic spring portion for damping chain vibration as disclosed in the present disclosure. The guide plate or guide link 10 configured to attach at the outermost rows of inner link plates or inner links 36 (shown and discussed with FIGS. 3A and 3B) of a power transmission chains 32 and 132 (shown and discussed with FIGS. 3A and 3B).

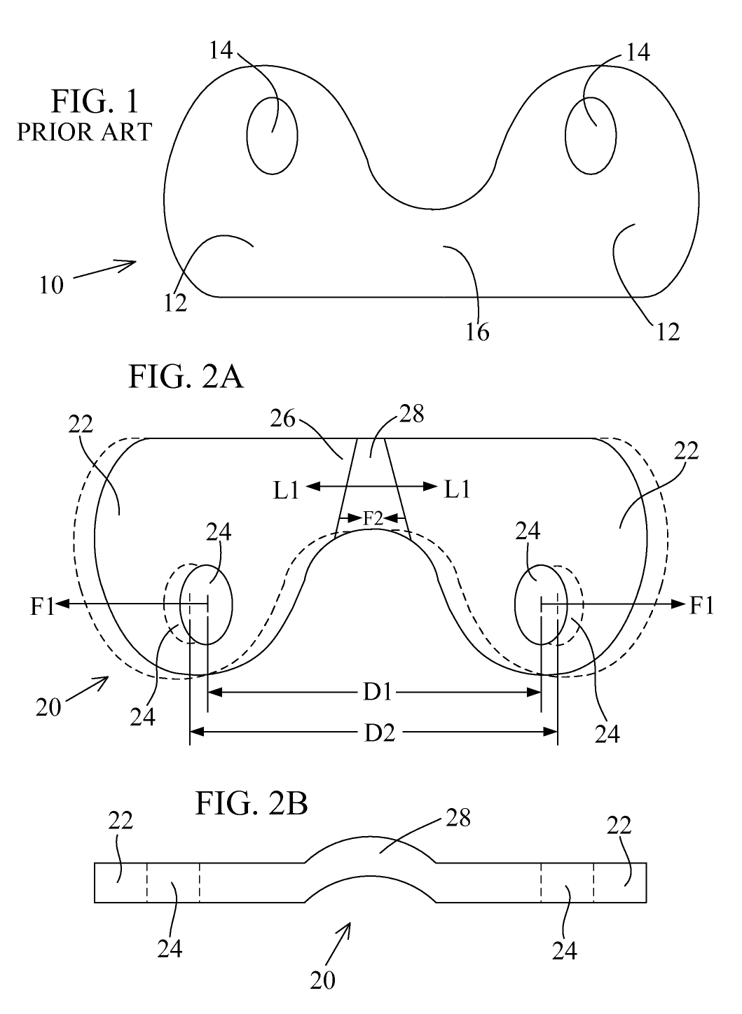

FIG. 2A illustrates a front view of a longitudinal spring damper link 20 in accordance with one or more aspects of the present invention. Longitudinal spring damper link 20 has a formed metallic body having two opposing ends 22. Each opposing end 22 is provided with an aperture 24 for receiving a roller pin 34 (shown and discussed with FIGS. 3A and 3B) therethrough. The longitudinal spring damper link 20 has a first distance D1 between the end apertures defined with the longitudinal spring damper link 20 as a free body (no external tensile force applied). The opposing ends 22 lie generally in a common plane. The middle section 26 is positioned between and interconnecting the opposing ends 22. The middle section includes a spring portion 28 which acts longitudinally along the spring damper chain link 20 to allow for elastic extension of the link generally in direction L1-L1 while offering resistance to the elongation of the link 20 by a counteracting internal tensile spring force F2 generated by deflection/elongation of the spring portion 28. The spring portion 28 enables the spring damper link 20 to elastically elongate in response to an external tensile force F1 applied to the tensilely displaced opposing end apertures 24 (shown with broken lines), wherein distance D2 between the displaced apertures 24 is greater than the first distance D1. The internal tensile force F2 generated by the spring portion 28 acts to return the distance between spring damper link apertures 24 to the first distance D1.

FIG. 2B illustrates a top view of the longitudinal spring damper link 20 of FIG. 2A as a free body (no external tensile forces applied). Longitudinal spring damper link 20 has a formed metallic body having two opposing ends 22. Each opposing end 22 is provided with an aperture 24 for receiving a roller pin (shown and discussed with FIGS. 3A and 3B) therethrough. The middle section includes a spring portion 28 as discussed with FIG. 2A above. In the specific embodiment illustrated in FIG. 2B, the spring portion 28 is a curved raised spring portion generally extending outwards from the link to one side of the link and in a direction generally normal to a plane defined by the end portions 22 of the longitudinal spring damper link 20. As can be seen in FIG. 2A, the spring portion 28 in the embodiment illustrated has a generally trapezoidal shape in FIG. 2A. The longitudinal spring damper link 20 is not limited to the use of a trapezoidal shape spring portion, but may instead be any shape such as a generally rectangular shape that achieves the counteracting internal tensile force F2 generating properties as discussed with FIG. 2A above. The spring portion 28 of the longitudinal spring damper link 20 is not limited to the use of the curved raised spring portion illustrated in the presented embodiment, but may instead be any configuration of longitudinally elastic spring portion configured to resist elongation by the generation of an internal tensile force F2 as discussed above with FIG. 2A.

FIG. 3A illustrates a top view of a power transmission chain 32 incorporating the longitudinal spring damper links 20 as guide links, the spring damper links 20 symmetrically arranged on opposing sides of the chain 32 in accordance with one or more aspects of the present invention. FIG. 3B illustrates a top view of a power transmission chain 132 incorporating the longitudinal spring damper links 20 as guide links, the spring damper links 20 in a staggered arrangement on opposing sides of the chain 132 in accordance with one or more aspects of the present invention. The power transmission chains 32 and 132 include a plurality of spaced parallel roller pins 34 configured with immediately adjacent roller pins 34 in a spaced parallel arrangement. A plurality of inner plates or inner links 36 are interleaved in rows of adjacent links. The inner links 36 are interconnected by the roller pins 34 inserted through apertures in the inner links 36. The rows of interconnected inner links 36 form an inner portion of the power transmission chains 32 and 132.

A plurality of longitudinal spring damper links 20 also serving as guide links are installed onto the opposing outermost rows of chains 32 and 132. For clarity in discussion herein, each outermost row is on an opposing side of the rows of inner links 36. As discussed in detail with FIG. 2A above, each longitudinal spring damper link 20 has a formed metallic body including two opposing ends 22 with each opposing end 22 (see FIG. 2A) having an aperture 24 (FIG. 2A) for receiving a roller pin 34 therethrough. As discussed in detail with FIG. 2A above, each longitudinal spring damper link is configured to generate an internal tensile force acting to reduce distance between the apertures 24 of the spring damper link 20, thereby urging the roller pins 34 into a closer spacing so as to tension the chains 32 and 132 to dampen longitudinal vibrations in chains 32 and 132. As illustrated in FIGS. 3A and 3B, the raised spring portion 28 of the longitudinal spring damper links 20 extends outwards from the inner links, specifically in a direction away from the inner links 36 of the chains 32 and 132.

In an optional embodiment of the invention, the longitudinal spring damper links 20 may be installed in the inner portion of the chain 32 or 132, replacing a portion of the inner links 36.

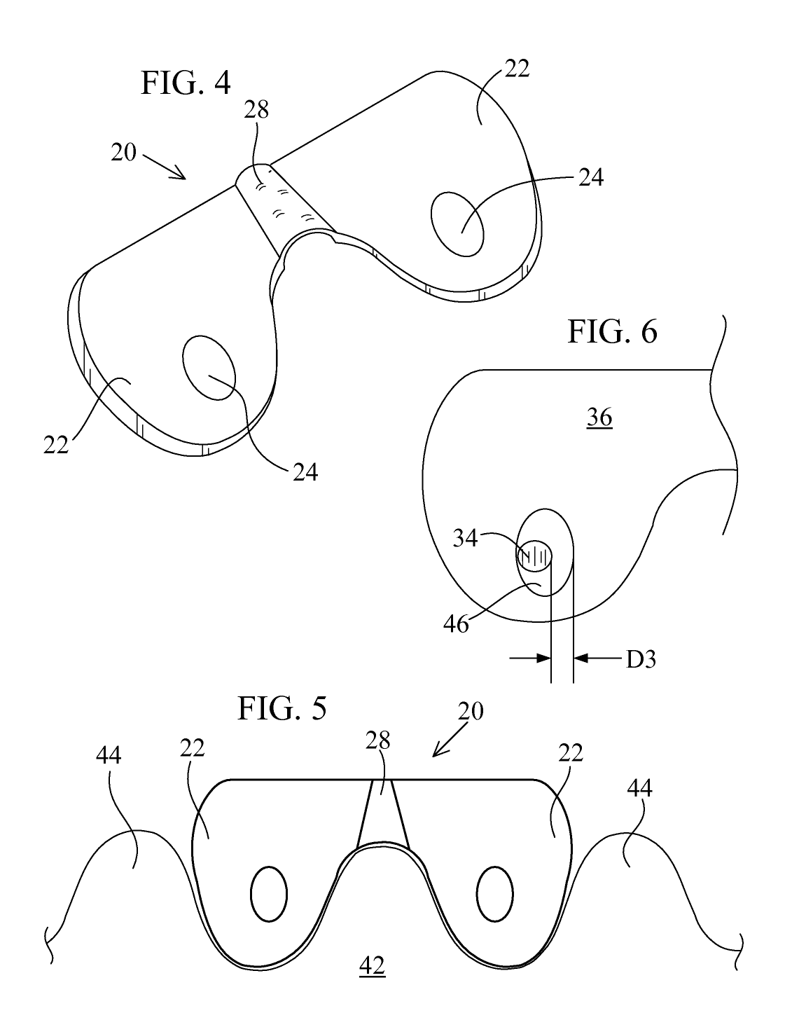

FIG. 4 illustrates a perspective view of the longitudinal spring damper link of FIGS. 2A and 2B, more clearly presenting the curved raised spring portion 28.

FIG. 5 illustrates a front view of a longitudinal spring damper link 20 (illustrated as a free body separate from the chain) having ends 22 configured to driveably engage sprocket teeth 44 of a sprocket wheel 42.

FIG. 6 illustrates a front view shown a portion of inner plate or inner link 36 (see FIGS. 3A and 3B) for a power transfer chain 32 or 132 (see FIGS. 3A and 3B) illustrating one end and aperture 46 of the inner link 36. FIG. 6 illustrates the tolerance gap D3 between the roller pin 34 and the aperture 46 of exemplary inner link 36. The tolerance gap D3 permits the roller pin 34 to traverse horizontally within of the aperture 46, changing horizontal position relative to inner link 36. The tolerance gap D3 is typically on the order of 0.1 mm to 1.0 mm. The tolerance gap D3 permits the roller pins 34 to move relative to the inner link 36, advantageously by the action of the internal tensile force F2 (see FIG. 2A) on the roller pins 34 as applied by the longitudinal spring link damper 20 (see FIGS. 3A and 3B). The cumulative effect of the tolerance gap in the inner links permits the internal tensile force F2 of the longitudinal spring damper links 20 in chains 32 and 132 to act to reduce distance between the apertures 24 of the spring damper link 20 and thereby urge the roller pins 34 into closer spacing so as to tension the chains 32 and 132 to dampen chain longitudinal vibrations. The apertures 24 of the longitudinal spring damper link 20 have a much tighter (i.e. smaller) tolerance distance than the apertures 46 of the inner links 36.

While the best modes for carrying out the invention have been described in detail, those familiar with the art to which this invention relates will recognize various alternative designs and embodiments for practicing the invention within the scope of the appended claims.

1. A longitudinal spring damper link comprising:
a formed metallic body comprising:
two opposing ends, each opposing end having an aperture for receiving a roller pin therethrough, said link having a first distance between said apertures, said ends lying generally in a plane;
a middle section positioned between and interconnecting said opposing ends, said middle section having an elastic spring portion which acts longitudinally along said spring damper chain link to allow for elastic extension of the link while resisting elongation of the link by an internal tensile spring force generated by said spring portion, said spring portion enabling said spring damper link to elastically elongate in response to an external tensile force applied to said opposing end apertures wherein said external force causes distance between said apertures to be greater than said first distance, wherein said internal tensile force generated by said spring portion acts to urge said spring damper link apertures to return to said first distance to thereby dampen vibrations.

2. The longitudinal spring damper link of claim 1, wherein said spring portion comprises a raised spring portion generally extending outwards from said link to one side of said link and in a direction generally normal to said plane.

3. The longitudinal spring damper link of claim 2, wherein said spring portion is a curved raised spring portion.

4. The longitudinal spring damper link of claim 1, wherein said spring damper link comprises spring steel.

5. The longitudinal spring damper link of claim 3, wherein said raised spring portion has a generally triangular shape.

6. The longitudinal spring damper link of claim 1, wherein said longitudinal spring damper link is a chain guide link.

7. A power transmission chain comprising:
a plurality of spaced parallel roller pins configured with immediately adjacent roller pins in a spaced parallel arrangement;
a plurality of inner links interleaved into rows of adjacent links, each of said links having a pair of apertures, said inner links interconnected by said roller pins inserted through said apertures, said rows of interconnected links forming an inner portion of said power transmission chain;
a plurality of longitudinal spring damper links, said spring damper links operable as guide links forming two opposing outermost rows of said chain, each outermost row on an opposing side of said rows of inner links, each spring damper link having a formed metallic body comprising:
two opposing ends, each opposing end having an aperture for receiving a roller pin therethrough, said longitudinal spring damper link having a first distance between said opposing end apertures, said ends lying generally in a plane; and
a middle section positioned between and interconnecting said opposing ends, said middle section having an elastic spring portion configured to enable said spring damper link to be elastically elongated in response to an external tensile force applied to said opposing end apertures, said spring portion configured to generate an internal tensile force resisting said elastic elongation;
wherein one inner link aperture in each row of inner links and one spring damper link aperture in each row of spring damper links has a common roller pin extending therethrough;
wherein said external tensile force causes distance between said opposing end apertures of said spring damper link to be greater than said first distance; and
wherein said internal tensile force acts to reduce distance between said apertures of said spring damper link thereby urging said roller pins into closer spacing to tension said chain to dampen chain longitudinal vibrations.

8. The power transmission chain of claim 7, wherein said spring portion comprises a raised spring portion generally extending outwards from said link to one side of said link and in a direction generally normal to said plane.

9. The power transmission chain of claim 8, wherein said spring portion is a curved raised spring portion.

10. The power transmission chain of claim 7, wherein said spring damper link comprises spring steel.

11. The power transmission chain of claim 9, wherein said raised spring portion has a generally triangular shape.

12. A power transmission chain for transmitting power from a sprocket wheel comprising:
a plurality of roller pins configured with immediately adjacent roller pins in a spaced parallel arrangement;
at least one row of inner links interleaved into rows of adjacent links, each of said links having a pair of apertures, said inner links interconnected by said roller pins inserted through said apertures, said rows of interconnected links forming an inner portion of said power transmission chain;
a plurality of longitudinal spring damper links, said spring damper links operable as guide links forming two opposing outermost rows of said chain, each outermost row on an opposing side of said rows of inner links, each spring damper link having a formed metallic body comprising:
two opposing ends, each opposing end having an aperture for receiving a roller pin therethrough, said longitudinal spring damper link having a first distance between said opposing end apertures, said ends lying generally in a plane; and
a middle section positioned between and interconnecting said opposing ends, said middle section having an elastic spring portion configured to enable said spring damper link to be elastically elongated in response to an external tensile force applied to said opposing end apertures, said spring portion configured to generate an internal tensile force resisting said elastic elongation;
wherein one inner link aperture in each row of inner links and one spring damper link aperture in each row of spring damper links has a common roller pin extending therethrough;
wherein said external tensile force causes distance between said opposing end apertures of said spring damper link to be greater than said first distance; and
wherein said tensile force acts to reduce distance between said opposing end apertures of said spring damper link thereby urging said roller pins into closer spacing to tension said chain to dampen chain longitudinal vibrations.

13. The power transmission chain of claim 12, wherein at least some of said longitudinal spring damper links include at least one of said ends configured to driveably engage a sprocket tooth of said sprocket wheel.

14. The power transmission chain of claim 12, wherein said spring portion comprises a raised spring portion generally extending outwards from said link to one side of said link and in a direction generally normal to said plane.

15. The power transmission chain of claim 14, wherein said spring portion is a curved raised spring portion.

16. The power transmission chain of claim 12, wherein said spring damper link comprises spring steel.

17. The power transmission chain of claim 15, wherein said raised spring portion has a generally triangular shape.

18. A power transmission chain comprising:
a plurality of spaced parallel roller pins configured with immediately adjacent roller pins in a spaced parallel arrangement;
a plurality of inner links interleaved into rows of adjacent links, each of said links having a pair of apertures, said inner links interconnected by said roller pins inserted through said apertures, said rows of interconnected links forming an inner portion of said power transmission chain;
a plurality of guide links forming two opposing outermost rows of said chain, each outermost row on an opposing side of said rows of inner links;
a plurality of longitudinal spring damper links, each spring damper link having a formed metallic body comprising:
two opposing ends, each opposing end having an aperture for receiving a roller pin therethrough, said longitudinal spring damper link having a first distance between said opposing end apertures, said ends lying generally in a plane; and
a middle section positioned between and interconnecting said opposing ends, said middle section having an elastic spring portion configured to enable said spring damper link to be elastically elongated in response to an external tensile force applied to said opposing end apertures, said spring portion configured to generate an internal tensile force resisting said elastic elongation;
wherein said longitudinal spring damper links replace a portion of said inner links and said guide links;
wherein said external tensile force causes distance between said opposing end apertures of said longitudinal spring damper links to be greater than said first distance; and
wherein said internal tensile force acts to reduce distance between said apertures of said spring damper link thereby urging said roller pins into closer spacing to tension said chain to dampen chain longitudinal vibrations.
